(19) United States
(12) Patent Application Publication
(10) Pub. No.: US 2016/0164889 A1
(43) Pub. Date: Jun. 9, 2016

(54) ROGUE ACCESS POINT DETECTION

(71) Applicant: Fortinet, Inc., Sunnyvale, CA (US)

(72) Inventor: Yong Zhang, Belmont, CA (US)

(73) Assignee: FORTINET, INC., Sunnyvale, CA (US)

(21) Appl. No.: 14/559,255

(22) Filed: Dec. 3, 2014

(51) Int. Cl. H04L 29/06

(52) U.S. Cl. CPC H04L 63/1416; H04L 63/164

(57) ABSTRACT

Methods and systems for detecting on-wire unauthorized/rogue access points (APs) within a network are provided. According to one embodiment, a potential rogue AP is detected by a managed access point (AP) within a network. The managed AP causes a network element on a wired side of the network to inject a special network packet having a defined pattern onto the network. When the managed AP detects the special network packet has been transmitted by the potential rogue AP, then the potential rogue AP is identified by the managed AP as a confirmed on-wire rogue AP.

### COPYRIGHT NOTICE

Contained herein is material that is subject to copyright protection. The copyright owner has no objection to the facsimile reproduction of the patent disclosure by any person as it appears in the Patent and Trademark Office patent files or records, but otherwise reserves all rights to the copyright whatsoever. Copyright ©2014, Fortinet, Inc.

### BACKGROUND

1. Field

Embodiments of the present disclosure generally relate to computer network security. In particular, embodiments of the present disclosure relate to detection of on-wire unauthorized/rogue access points (APs), specifically, layer 3 rogue APs within a network.

2. Description of the Related Art

Security of computer networks is an essential and prime concern for every organization using a computer network. A typical organization may have a computer network that includes several wired and/or wireless access points (APs) to provide connectivity within the corporate network or outside the corporate network, referred to generally as a secured network. There are several security measures, such as authentication of users, authentication of user devices, authentication of other network entities/elements, among others that need to be taken into consideration by the Information Technology (IT) department in order to restrict access of secure network by an unauthorized user/device. Network entities, such as access points (APs) are vulnerable targets used by hackers to gain access to secured network(s), putting the compromised corporate network at risk. Unauthorized access to a network and/or to devices attached to the network may not only place at risk the valuable resources and information of the organization, but can also impact client information and an organization's reputation. Hence, each network needs to be secured with only authorized network elements being attached to the network and/or having access to the network/network resources.

In a typical network, such as a corporate internal network, several wireless access points are installed to provide wireless connectivity to user devices accessing one or more network resources. One of the most challenging network security issues currently prevalent includes detection and removal of on-wire unauthorized/rogue wireless APs, also referred to as “rogue access points (APs)”. Rogue access points (APs), such as those brought into a secured network by employees of an organization or by students of a college, for example, pose a severe security threats, as they may be poorly managed and/or insufficiently secured. Rogue APs can also be set up by malicious entities in a public access Wi-Fi network and such rogue APs may be assigned the same or similar Service Set Identification (SSID) or Extended SSID (ESSID) as that of a genuine hotspot. When a user of the public Wi-Fi network mistakenly connects to this rogue hotspot, the rogue hotspot (AP) is able to intercept all of the user's data packets and can potentially obtain confidential information. If the rogue AP is further configured to redirect the client device to a spoofed login page, then the user's login information to the real public Wi-Fi network could also be obtained.

Sometimes, the unauthorized installation of rogue APs within a secured network can be used by attackers to get into the internal network through one or more of the rogue APs, bypassing all perimeter security measures. For example, an employee might decide to attach the AP to a company communication network without proper authorization. In other words, the employee may be authorized to use the company network, but the use of his AP may not be authorized. The employee may have decided to use his own AP for more convenient access to the company network. If the AP is not properly configured to provide secure access to only authorized users, then unauthorized users who obtain compatible hardware, may access the communication network. This may be of particular concern when the AP covers an area outside of the employer's facilities, in which scenario, unauthorized users may access the communication network without physically entering the employer's premises. Also, in some cases, rogue APs can be intentionally set up by malicious attackers with a view to simply deny access of the network to a valid user, or to attract traffic towards them and obtain sensitive information from users. This can leave assets of the company/network under attack exposed to a casual snooper or a criminal hacker.

Existing wireless protocols do not provide authentication mechanisms for determining whether an AP is a valid AP or a rogue one. For example, when an 802.11 MS attempts to connect to a given network, it scans the environment and looks for APs located nearby, and automatically selects the best available AP and connects with it. For example, Windows XP automatically scans and connects to the best AP possible in the vicinity. In some known implementations, wireless protocols allow the network to authenticate the user device/user being connected to the network but not the AP being used by that device. Due to this behavior, in some cases, authorized clients of an organization can connect with APs from a neighboring organization as well, with such APs not being managed, and therefore not being monitored/controlled by the administrator of the neighboring organization.

In certain existing solutions for detection of rogue APs, a two-step process has been incorporated, starting with discovering the presence of an AP in the network, and then proceeding to identify whether the AP is a rogue one or not. Such solutions can typically be classified into Radio Frequency (RF) scanning, AP scanning, or use of wired line inputs. RF scanning, which is suitable for WLANs, is generally performed by placing RF sensors over a secured network, wherein these sensors are mainly APs that only perform packet capture and analysis, detect any wireless device operating in the area, and alert an administrator of the secured network. However, the RF scanning method exhibits certain limitation in a case where a rogue AP may be placed in a dead zone, which is not covered by the sensors. Such a rogue AP might go unnoticed for an extended period of time until more sensors are added, for example.

Another method used in the prior art involves AP scanning, which includes deploying APs enabled with a scanning device for discovering all APs operating in a nearby area. Although the method is useful, only limited AP vendors have this functionality implemented in their products. In addition, the ability of an AP enabled with AP scanning is limited to a very short range. Rogue APs operating outside this coverage area can go unnoticed. Furthermore, using this method, even if an unauthorized AP is detected, the system cannot confirm whether the AP is located within the secured network area, thereby giving rise to the possibility of a false indication of the existence of an unauthorized AP being issued, when, in fact, the AP may actually be located in a nearby area and therefore may not, in reality, cause any security concern to the secured network. Such access from outside the secure network can be blocked by the gateway or firewalls.

In an attempt to detect a rogue AP that may actually be present inside the secured network, a wired side input technique may be incorporated, wherein the technique detects devices physically connected to a LAN network. Such a technique is generally reliable and proven as it can detect an AP anywhere in the LAN, irrespective of its physical location. Moreover, wireless Network Management Systems (NMS) can, in addition, constantly monitor these APs for their health and availability. One limitation with this method is that any AP that doesn't support the respective network management software goes unnoticed by the network management software.

Once an AP is discovered in the first step, the next step is to identify whether it is a rogue AP or not, which is not an easy task. Existing systems rely on a list of authorized Media Access Control (MAC) addresses to determine whether the AP is an authorized AP or a rogue AP. However, this approach is vulnerable to MAC address spoofing. Also, the existing wired side input technique is mostly used for detecting a layer-2 AP, wherein a layer-2 AP is an AP device that acts like a bridge to convert a packet received at wired interface to a packet to be transmitted over the wireless network.

As described above, most of the presently available rogue AP detection methods such as wired side input techniques look for a correlation between devices seen on the wired side of the network and devices seen on the wireless side. Such mechanisms work only for layer-2 APs, such as a bridge, as the solution mostly relies on MAC addresses of the APs to determine whether they are authorized or not. For a layer-2 AP, the MAC address of a wired interface is visible at the wireless interface and therefore can be used to determine authorized APs based on their MAC addresses. However, in the case of a layer-3 (ISO L3) AP, such as a router AP, MAC addresses on the wired side are not visible to the network when communicating through the AP. As a result, existing techniques are unable to detect whether a layer-3 AP is an authorized AP or a rogue AP.

There is therefore a need for systems and methods that enable efficient and accurate detection of rogue APs that can work for both layer-2 and layer-3 APs.

### SUMMARY

Methods and systems are described for detecting on-wire unauthorized/rogue access points (APs) within a network. According to one embodiment, a potential rogue AP is detected by a managed access point (AP) within a network. The managed AP causes a network element on a wired side of the network to inject a special network packet having a defined pattern onto the network. When the managed AP detects the special network packet has been transmitted by the potential rogue AP, then the potential rogue AP is identified by the managed AP as a confirmed on-wire rogue AP.

Other features of embodiments of the present disclosure will be apparent from accompanying drawings and from detailed description that follows.

### BRIEF DESCRIPTION OF THE DRAWINGS

In the Figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 illustrates an exemplary network architecture having a rogue access point (AP).

FIG. 2 is a block diagram of an exemplary managed AP in accordance with an embodiment of the present invention.

FIG. 3 is a conceptual illustration of an on-wire rogue AP confirmation process in accordance with an embodiment of the present disclosure.

FIG. 4A illustrates exemplary functional modules of a network controller in accordance with an embodiment of the present disclosure.

FIG. 4B illustrates exemplary functional modules of a managed AP in accordance with an embodiment of the present disclosure.

FIG. 5 is a flow diagram illustrating rogue AP evaluation and detection processing in accordance with an embodiment of the present disclosure.

FIG. 6 is an exemplary computer system in which or with which embodiments of the present invention may be utilized.

### DETAILED DESCRIPTION

Methods and systems are described for detecting on-wire unauthorized/rogue access points (APs) within a network. Systems and methods are also described for detection and confirmation, by a managed AP, of presence of on-wire unauthorized/rogue AP, wherein a potential rogue IP can be detected/identified using MAC address validation and presence of the on-wire rogue AP can be confirmed by injecting a special network packet at wired side of the network and detecting whether the special network packet is transmitted by the potential rogue AP such that when a result of detection is affirmative, the potential rogue AP can be identified/confirmed as an on-wire rogue AP.

In the following description, numerous specific details are set forth in order to provide a thorough understanding of embodiments of the present disclosure. It will be apparent to one skilled in the art that embodiments of the present disclosure may be practiced without some of these specific details.

Embodiments of the present disclosure include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, firmware and/or by human operators.

Embodiments of the present disclosure may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more machine-readable storage media containing the code according to the present disclosure with appropriate standard computer hardware to execute the code contained therein. An apparatus for practicing various embodiments of the present disclosure may involve one or more computers (or one or more processors within a single computer) and storage systems containing or having network access to computer program(s) coded in accordance with various methods described herein, and the method steps of the disclosure could be accomplished by modules, routines, subroutines, or subparts of a computer program product.

If the specification states a component or feature “may”, “can”, “could”, or “might” be included or have a characteristic, that particular component or feature is not required to be included or have the characteristic.

Although the present disclosure has been described with the purpose of conducting network auditing, it should be appreciated that the same has been done merely to illustrate the disclosure in an exemplary manner and any other purpose or function for which the explained structure or configuration can be used, is covered within the scope of the present disclosure.

Exemplary embodiments will now be described more fully hereinafter with reference to the accompanying drawings, in which exemplary embodiments are shown. This disclosure may, however, be embodied in many different forms and should not be construed as limited to the embodiments set forth herein. These embodiments are provided so that this disclosure will be thorough and complete and will fully convey the scope of the disclosure to those of ordinary skill in the art. Moreover, all statements herein reciting embodiments of the disclosure, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating systems and methods embodying this disclosure. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this disclosure. Those of ordinary skill in the art further understand that the exemplary hardware, software, processes, methods, and/or operating systems described herein are for illustrative purposes and, thus, are not intended to be limited to any particular named.

Aspects of the present disclosure relate to a method for detecting a rogue AP by means of a managed AP, wherein the method includes detecting, by the managed access point (AP) within a network, a potential rogue AP in the network, and causing, by the managed AP, a network element within a wired side of the network to inject a special network packet having a defined pattern onto the network. The method can further include detecting, by means of the managed AP, whether the potential rogue AP transmits the special network packet such that when the result of such detection is affirmative, the potential rogue AP can be confirmed as an on-wire rogue AP.

In an aspect, the network element can include, but is not limited to, one or a combination of a network controller, a gateway, a router, a firewall, a hub, and a switch. In another embodiment, detection of a potential rogue AP in the network can include scanning, by the managed AP, the network for an AP that is not among those on a list of valid APs. In an embodiment, the list of valid APs can include Media Access Control (MAC) addresses of the valid APs. The method for detecting a rogue AP can include injecting, by the network element, the special network packet through a wired interface within one or more communication sessions associated with the potential rogue AP. In an exemplary aspect, the one or more communication sessions can include a transmission control protocol (TCP) session, where the special network packet can include a TCP packet. In another exemplary aspect, the one or more communication sessions can include a user datagram protocol (UDP) session, where the special network packet can include a UDP packet.

According to one embodiment of the present disclosure, the defined pattern of the special network packet can include a length of the special network packet. According to another exemplary embodiment, the potential rogue AP can include a layer 3 AP. According to yet another embodiment, detection of whether the special network packet is transmitted by the potential rogue AP can include receiving, by the managed AP, the special network packet on a wireless interface of the managed AP.

According to one embodiment, a system for detecting a rogue access point (AP) includes a potential rogue AP identification module, operable within a managed AP of a network that is configured to detect a potential rogue AP in the network, a special packet injection module configured to inject a special network packet having a defined pattern onto the network, a rogue AP evaluation module configured to detect whether the special network packet is transmitted by the potential rogue AP such that, responsive to receiving an indication from the rogue AP evaluation module that the special network packet has been transmitted by the rogue AP evaluation module, the managed AP identifies the potential rogue AP as a confirmed on-wire rogue AP.

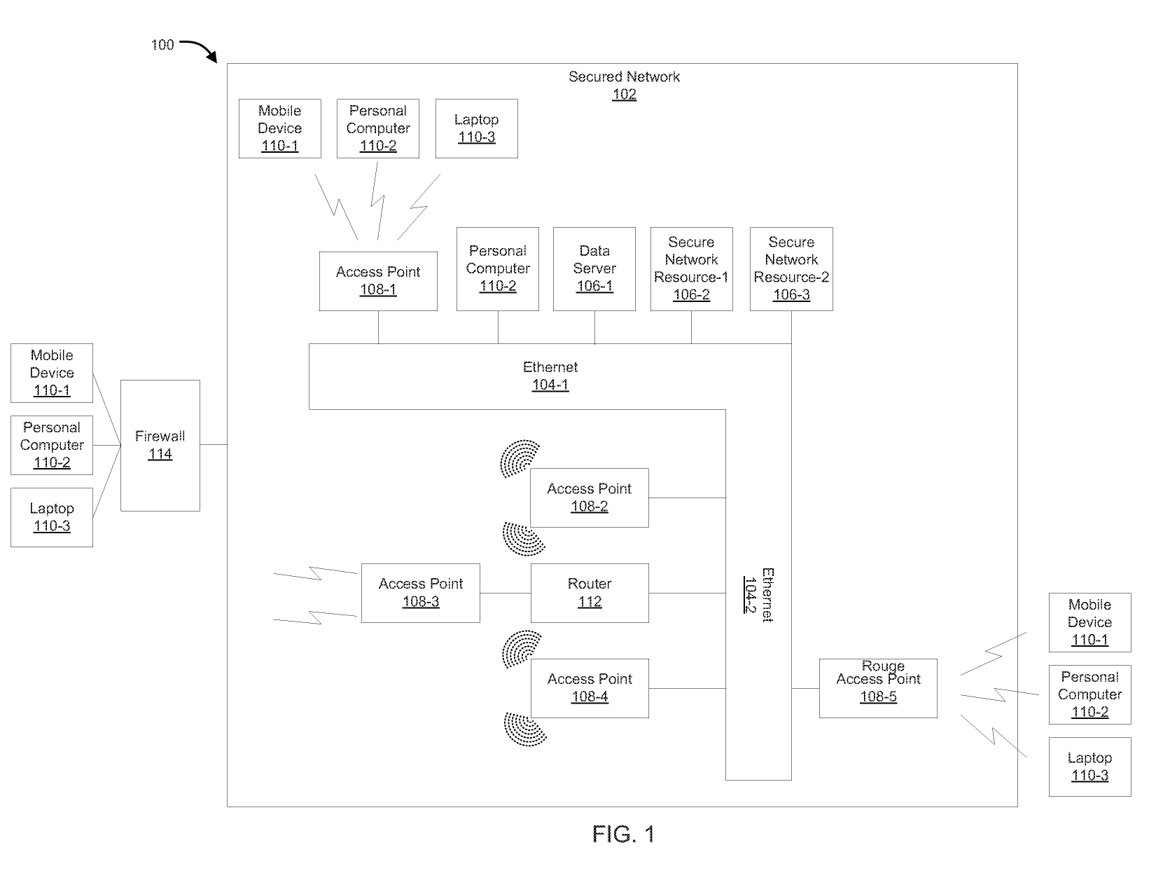

FIG. 1 illustrates an exemplary network architecture 100 that can facilitate detection and confirmation of on-wire rogue AP in accordance with an embodiment of the present disclosure. Network architecture 100 includes a simplified secure network 102 used merely as an example to illustrate various embodiments of the present invention. Those skilled in the art will recognize many variations, alternatives, and modifications can be made to secured network 102. As such, secured network 102 is not intended to be limiting on embodiments of the present invention.

In the context of the present example, secure network 102 can have core transmission infrastructure including, but not limited to, various transmission components, e.g., Ethernet cables, hubs and switches/routers. In a typical deployment, secure network 102 can include one or more network segments/sub-networks providing connectivity to network elements and user devices. In the present illustration, Ethernet 104-1 and Ethernet 104-2 may provide the backbone connectivity to secure network 102. One or more connection ports can be provided through Ethernet 104-1 and Ethernet 104-2, which may be collectively referred to as Ethernet 104, for connecting various network elements and user devices such as data server 106-1, secure network resource-1 106-2, secure network resource-2 106-3, access point 108-1, access point 108-2, access point 108-3 (coupled to Ethernet 104-2 via router 112), access point 108-4, rogue access point 108-5, personal computer 110-2, and router 112, among any other network element/managed device/computing device. In a typical WLAN deployment, there may be several layer 3 wireless access points (APs) such as access point 108-1, access point 108-2, access point 108-3, and access point 108-4, which may be collectively and interchangeably also referred to as APs 108. APs 108 may be connected to the wired network of secure network 102 through Ethernet 104, and each of APs 108 can provide wireless connectivity to one or more user devices such as mobile device 110-1, personal computer 110-2, and laptop 110-3, which may be collectively and interchangeably referred as user device(s) 110.

Although the exemplary illustration of FIG. 1 shows a limited number of APs 108 and user devices 110 in the secured network 102, in different deployments, there can be any number of APs 108, and any number of user device(s) 110 connected to secure network 102 through such APs 108. In an exemplary deployment, user devices 110 (e.g., personal desktop computers, notebook computers, mobile phones, PDAs, laptops, handheld devices) can be connected to secure network 102 through APs 108 via one or more wireless interfaces or can be directly connected to the secure network 102 through wired interface, e.g., RJ 45 ports.

In an aspect, other computing systems that provide specific functionalities and services can also be connected to the secure network 102 and can be accessed by user device(s) using one or more APs 108. For example, one or more secure database computers (e.g., computers storing customer accounts, inventory, employee accounts, financial information, etc.) may be connected to secured network 102 via one or more AP 108. Additionally, one or more data servers 106-1 (computers providing services, such as database access, email storage, HTTP proxy service, DHCP service, SIP service, authentication, network management, etc.) may be connected to secured network 102 via one or more AP 108.

In an exemplary deployment, secure network 102 may have an extended wireless network created by the installation of one or more APs 108 as described above. In an exemplary implementation, each AP connecting the data server/secure network resource 106 with one or more user device(s) may need to be authenticated and managed by say the network controller (not shown). There may be a network controller (not shown) or any other network element and/or resource 106 and/or router 112 in the secured network 102 that can be configured to perform certain complex procedures (e.g., procedures for authentication, encryption, QoS, mobility, firewall, etc.) as well as for providing centralized management functionality for APs 108.

As shown in FIG. 1, in an embodiment, an unauthorized/rogue access point 108-5 can also be connected to secure network 102 through Ethernet 104, wherein unauthorized AP 108-5 can be a malicious AP, a wrongly configured AP, or a soft AP, generally interchangeably referred to as a rogue AP. A rogue AP can also be defined as an AP that does not have authorization for connecting to a secured network (e.g., secured network 102) or which has been connected to secured network 102 through wrongful means. In another aspect, a rogue AP can also include an AP operated by a person having physical access to the facility and connected to the secure network such as 102 without the permission of the network administrator, and may not be authorized by the network controller. Rogue AP 108-5 may pose a number of security risks to secure network 102. For example, an intruder may be able to connect to secure network 102 and launch attacks through rogue AP 108-5 (e.g., using the radio signal spillage of rogue AP 108-5 outside the region of operation of the secured network).

In an exemplary deployment, APs 108 can include layer 2 APs and/or layer 3 APs that can deliver data packets between the wired Ethernet 104 segment and the wireless user device 110. A layer 3 AP can be configured to route IP packets received on its wired interface to a user device connected to its wireless interface and vice versa. Layer 3 APs can further perform translation of IP addresses and port numbers in the packets before transferring them between the wired LAN segment and the wireless medium. As discussed in the Background, the MAC address of a layer-3 AP is not exposed to the wired side. Furthermore, the wired side and wireless side interfaces of a layer 3 AP are usually parts of different subnets.

In an exemplary implementation, any managed access point within secured network 102 can be tasked to monitor the air by scanning all APs 108 connected with secured network 102 and verify their MAC addresses against a list of valid MAC addresses. Any AP whose MAC address is not be found on the MAC address list can be identified as a potential rogue AP. In an exemplary embodiment, access point 108-1 can scan secured network 102 and can identify all other APs, and can further determine that AP 108-5 is a potential rogue AP by comparing MAC address of all APs found against a list of valid MAC addresses, based on which AP 108-5 can be identified as a potential rogue AP since the MAC address of AP 108-5 would not be in the list of valid MACs.

In an embodiment, once a potential rogue AP (e.g., rogue AP 108-5) has been identified, a network element/device (e.g., a controller, a gateway, a router or any other network element/device) within secured network 102 and that is connected with Ethernet 104, i.e., the wired network, can be configured to inject one or more special network packets (e.g., a packet having a special pattern or defined size (so as to be distinguishable from typical data/control packets routinely observed on secured network 102) onto the wired side of secured network 102 for one or more communication sessions associated with the identified potential rogue AP (e.g., rogue AP 108-5). The potential rogue AP can be confirmed to be a rogue AP when a managed AP observes one of the special network packets (which could only have been retransmitted by the potential rogue AP) on the wireless side of secured network 102.

According to an embodiment, the network element/device that can be configured to inject the special network packets can include one or a combination of a network controller, a gateway, a router such as router 112, a firewall such as firewall 114, a hub, a managed AP, a switch, among any other network element/network device connected to the wired side of secured network 102. In an exemplary implementation, a configured network controller can be used to inject different types of special packets (e.g., in the form of TCP packets and UDP packets at the wired interface depending on the communication sessions being used by the potential rogue AP. When a TCP communication session is observed to be one of the communication sessions associated with the potential rogue AP, the injected special network packets can be TCP packets, wherein when a UDP communication session is observed to be one of the communication sessions being used by the potential rogue AP, the injected special network packets can be UDP packets.

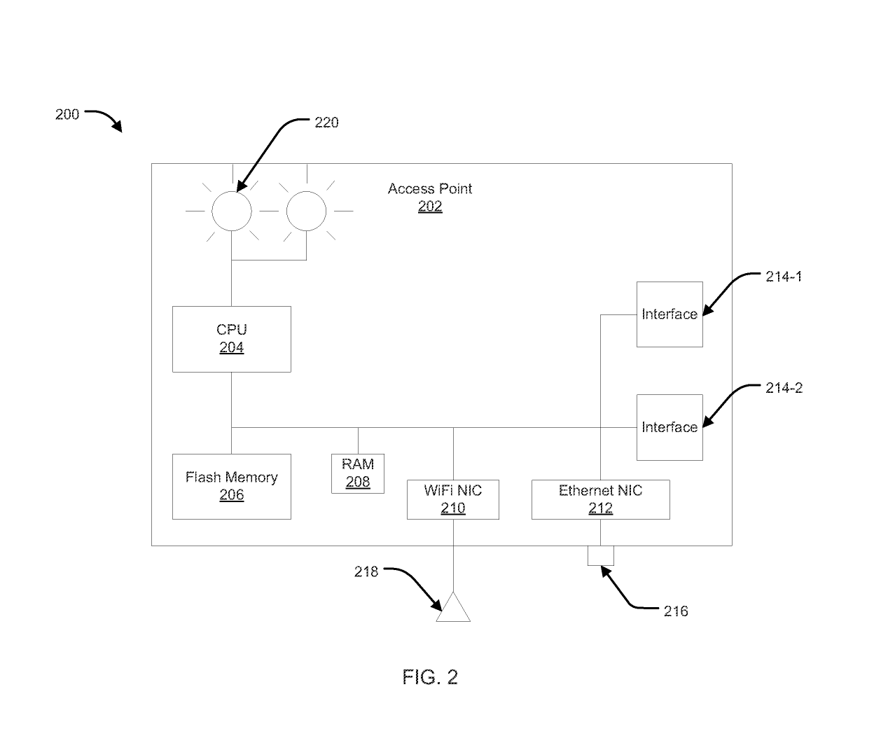

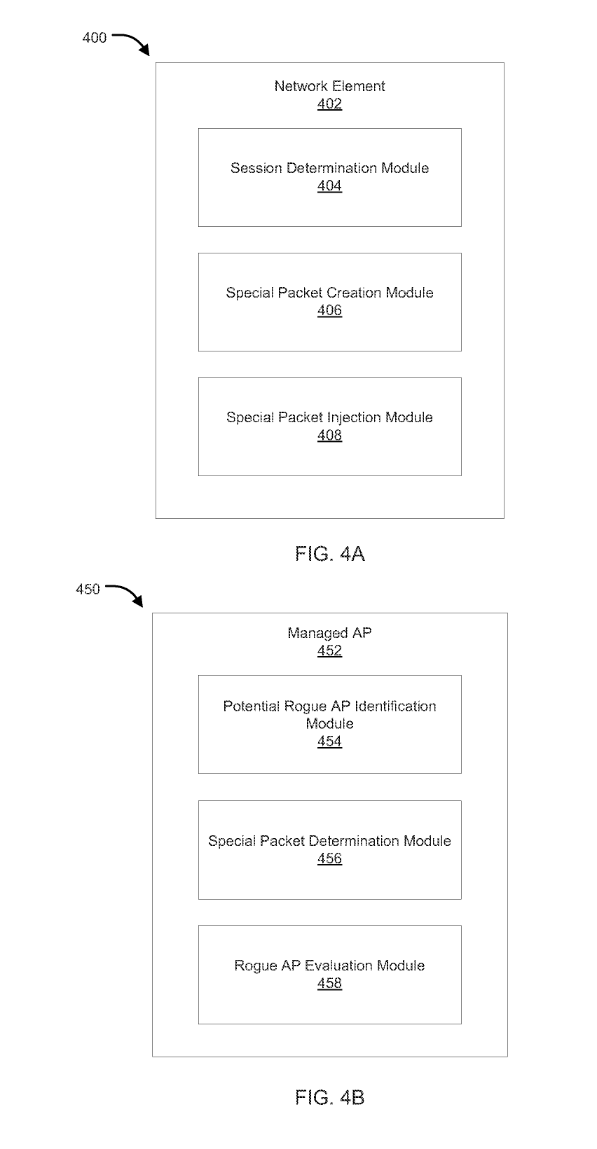

FIG. 2 illustrates an exemplary block diagram 200 of a managed AP in accordance with an embodiment of the present invention. The representation 200 is exemplary in nature, and therefore the structure/construction of the AP should not be construed as limiting on the scope of the present invention. In the context of the present example, managed AP 202 includes a central processing unit (CPU) 204, a flash memory 206, which may contain one of more of the functional units described below with reference to FIG. 4B, and a RAM 208 that serves as volatile memory during program execution. Managed AP 202 can also have one or more 802.11 wireless network interface cards (NICs), such as WiFi NIC 210 that can receive and transmit packets via WiFi onto the wireless side of secured network 102, for example, and Ethernet NIC 212 that can receive and transmit packets from/to the wired side of secured network 102, for example.

In an exemplary implementation, wireless NIC 210 can include a radio of 2.4 GHz and 5 GHz (to allow for transmission detection in both the 2.4 GHz and 5 GHz radio frequency spectrums) or dual band antennas 218 coupled thereto. Wireless NIC 210 can also operate in a, b, g, b/g, or a/b/g modes. In the exemplary implementation, Ethernet NIC 212 can be configured to perform Ethernet physical and MAC layer functions, wherein NIC 212 can be operatively coupled with an Ethernet jack 216 such as an RJ-45 socket for connecting managed AP 202 to a wired LAN with optional power over Ethernet (POE), and a serial port such as interface 214-1 that can be used to flash/configure/troubleshoot managed AP 202. Managed AP 202 can also have a power input interface 214-2. One or more light emitting diodes (LEDs) 220 can be provided within managed AP 202 to convey visual indications (such as device working properly, error conditions, unauthorized wireless device alert, and so on). Wired connectivity between a secured network and managed AP 202 can be provided through Ethernet jack 216 and user device(s) can connect wirelessly through antennas 218 to managed AP 202, and then to the secured network of which managed AP 202 forms a part.

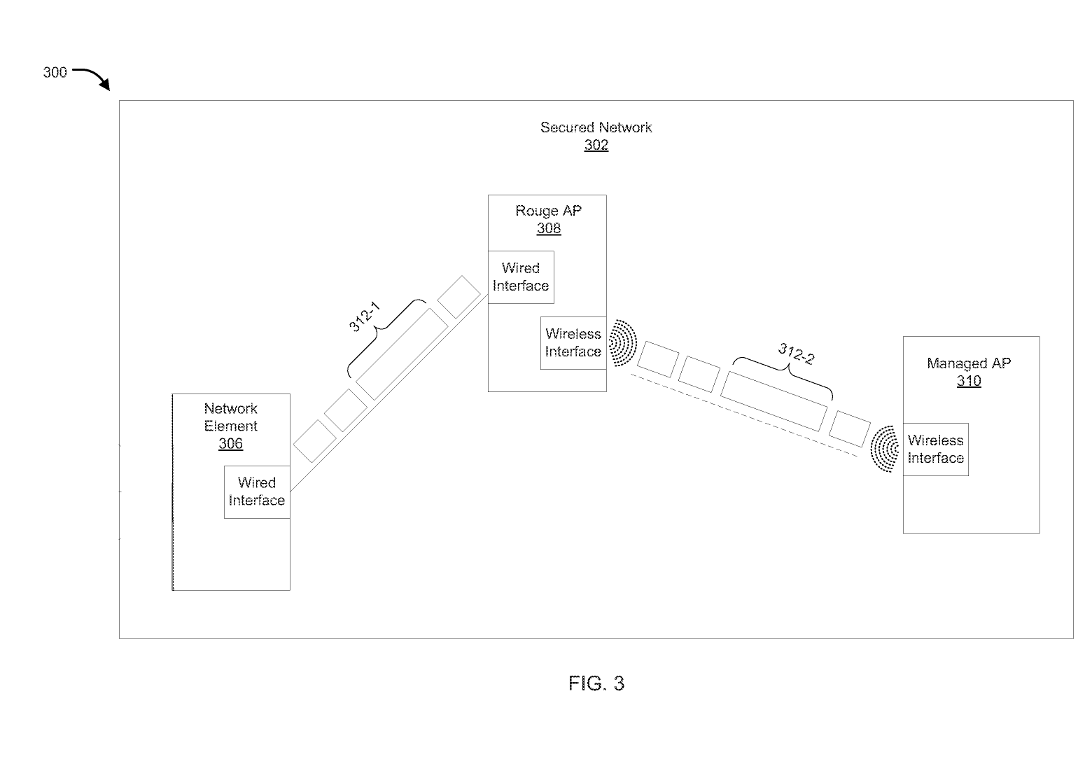

FIG. 3 is a conceptual illustration of an on-wire rogue AP confirmation process in accordance with an embodiment of the present disclosure. For purposes of simplicity, a secured network 302 is shown including only the network devices that are involved in the process, i.e., a rogue AP 308, a managed AP 310 and a network element 306, which may be a wireless controller in wired connectivity with rogue AP 308. Managed AP 310 is also in wireless connectivity with rogue AP 308.

According to one embodiment, responsive to detection of rogue AP 308 as a potential rogue AP (e.g., via AP scanning and subseqeuent MAC address validation), network element 306 creates and sends one or more special network packets (e.g., special network packet 312-1) on the wired-side of secured network 302. Since, as a wireless controller or gateway, network element 306 has a session list of all traffic traversing it, network element 306 can inject the one or more special network packets into sessions associated with the potential rogue AP. When the special network packets are received by the wired interface of rogue AP 308, rogue AP 308 dutifully retransmits them through its wireless interface. In this manner, special network packet 312-2 can be detected over the air by managed AP 310 by performing a pattern matching process on packets received on its wireless interface to identify special network packet 312. Since only an on-wire rogue AP would be capable of retransmitting special network packet 312 injected by network element 306, detection of special network packet 312 on its wireless interface allows managed AP 310 to confirm rogue AP 308 as an on-wire rogue AP. If special network packet 312 is not detected by managed AP 310 within a particular timeframe, then rogue AP 308 is not an on-wire rogue AP. That is it is not physically connected to secured network 302.

In one embodiment, special network packet 312 is a network packet having a special size (e.g., either larger or smaller than typical network traffic observed on secured network 302). Depending upon the particular implementation, apart from size, any other parameters, such as a defined pattern, format, type, among others can be incorporated so as to make it easy for managed AP 310 to detect special network packet 312 when transmitted by the wireless interface of rogue AP 308.

According to one embodiment, network element 306 can include one or a combination of a network controller, a gateway, a router, a firewall, a hub, a managed AP and a switch. Network element 306 can also have both wired and wireless interface (not shown) to provide connectivity to the wireless side of secured network 302. In an exemplary implementation, network element 306 can be configured to inject different types of special packets (e.g., TCP packets and/or UDP packets) onto the wired side of secured network 302, depending on the communication sessions being used by the potential rogue AP. For instance, when a TCP communication session is being used by the potential rogue AP, a special network packet in the form of a TCP packet can be injected into the session. Similarly, when a UDP communication session is being used by the potential rogue AP, a special network packet in the form of a UDP packet can be injected into the session. In an exemplary implementation, upon confirming the potential rogue AP as an on-wire rogue AP (e.g., upon detecting special network packet 312 on its wireless interface), managed AP 310 can notify network element 306 about the presence of on-wire rogue AP 308, based on which network element 306 can block on-wire rogue AP 308 and can further notify the network administrator about the presence of on-wire rogue AP 308.

FIG. 4A illustrates exemplary functional modules 400 of a network element in accordance with an embodiment of the present disclosure. Those skilled in the art will appreciate that these functional modules are merely exemplary as the functionality described here can be combined and/or distributed in a variety of different ways. According to one embodiment, network element 402 can include a session determination module 404, a special packet creation module 406 and a special packet injection module 408. In an exemplary implementation, session determination module 404 can be configured to determine and/or identify one or more communication sessions in which a potential rogue AP is participating.

According to one embodiment, special packet creation module 406 can be configured to create one or more special network packets that can be injected through the secured wired network to the potential rogue AP. Those skilled in the art will appreciate that the special network packets as created by special packet creation module 406 can be packets having a special pattern (e.g., contained in the payload) or a special characteristic (e.g., a larger size or a smaller size than those typically observed on the network at issue), so as to differentiate them from regular TCP or UDP control/data packets and to make it easy for the managed AP to detect the special network packets. Special packet creation module 406 can also be configured to determine whether the communication sessions associated with the potential rogue AP include TCP sessions and/or UDP sessions. According to one embodiment, module 406 can use any known network packet creation sub-system, including, but not limited to, Nping, to create the special network packets that can be targeted to a specific host.

According to one embodiment, special packet injection module 408 can be configured to intercept/interfere with existing communication sessions associated with the potential rogue AP, and inject the special network packet(s) as created by the module 406 in such a way that the special network packet(s) become part of the normal communication stream. In an exemplary implementation, the special network packets can be created and injected by utilizing raw sockets, NDIS function calls, or direct access to a network adapter kernel mode driver. In another exemplary implementation, the special packet injection module 408 can use an existing packet injection tool, including, but not limited to, Iorcon, KisMAC, WinPCap, Winsock, T50, Nemesis etc. for injecting the special network packets in the communication streams flowing through the potential rogue AP.

FIG. 4B illustrates exemplary functional modules 450 of a managed AP in accordance with an embodiment of the present disclosure. Those skilled in the art will appreciate that these functional modules are merely exemplary as the functionality described here can be combined and/or distributed in a variety of different ways. According to one embodiment, managed AP 452 can include a potential rogue AP determination module 454, a special packet determination module 456, and a rogue AP evaluation module 458. In an embodiment, the managed AP 452, by means of potential rogue AP determination module 454, can be configured to scan all available APs in order to detect potential rogue APs within a secured network, wherein the managed AP 452, in an implementation, can be connected with and managed by say a network controller and may have a list of MAC addresses of valid/authenticated APs. In an example implementation, the potential rogue AP identification module 454 can be configured to scan all the available APs within the secure network and compare MAC addresses of all observed APs for their presence in the list of MAC addresses of valid APs, such that when the MAC address of a given AP is not in the list of MAC addresses of valid APs, the given AP can be identified as a potential rogue AP by potential rogue AP identification module 454.

After identifying a potential rogue AP, managed AP 452 can notify network element 402 of the detection of the potential rogue AP, responsive to which network element 402 may activate packet creation module 406 and packet injection module 408 so as to enable processing of one or more special network packets by the potential rogue AP. According to one embodiment, special packet determination module 456 can be configured to receive and/or detect the special network packet(s) transmitted by the potential rogue AP as injected by network element 402 or in a form expected to be transmitted by the potential rogue AP. Rogue AP evaluation module 458 can be configured to confirm the presence of an on-wire rogue AP based on whether a special network packet is observed by managed AP 452 on one of its wireless interfaces during an expected time frame, for example.

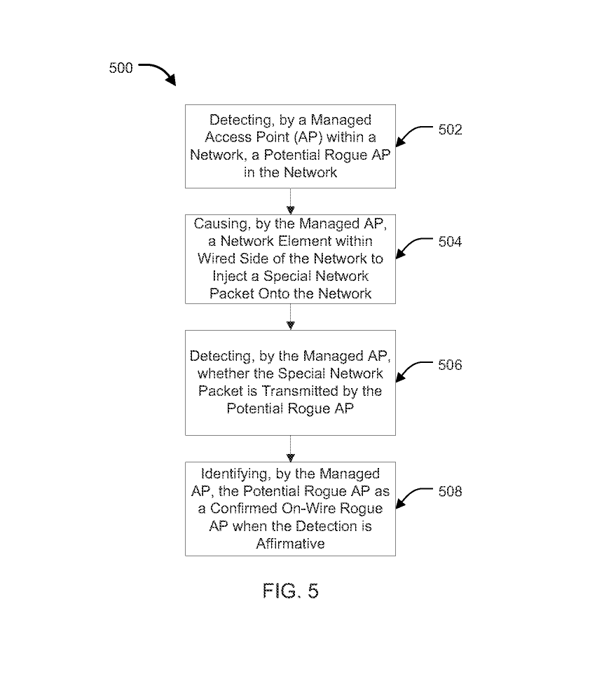

FIG. 5 is a flow diagram 500 illustrating rogue AP evaluation and detection processing in accordance with an embodiment of the present disclosure. At step 502, a managed AP within a secured network can detect a potential rogue AP in the secured network. At step 504, the managed AP can cause a network element of the secured network to inject a special network packet (e.g., having a defined pattern) onto the wired side of the secured network, and at step 506, the managed AP can detect whether the special network packet is transmitted through a wireless interface of the potential rogue AP such that when a result of said detecting is affirmative, then, at step 508, the managed AP can confirm the potential rogue AP as an on-wire rogue AP.

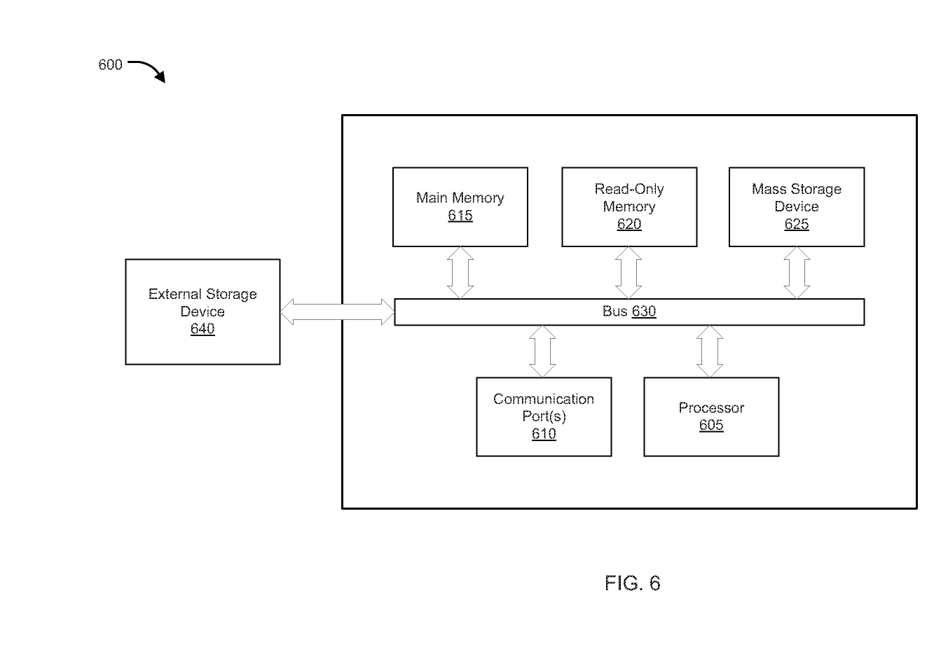

FIG. 6 is an example of a computer system 600 with which embodiments of the present disclosure may be utilized. Computer system 600 may represent or form a part of a network element (e.g., a wireless network controller that manages one or more APs of a WLAN), a managed AP or other network device incorporating the functionality of one or more of the functional units of FIG. 4A or 4B.

Embodiments of the present disclosure include various steps, which have been described in detail above. A variety of these steps may be performed by hardware components or may be tangibly embodied on a computer-readable storage medium in the form of machine-executable instructions, which may be used to cause a general-purpose or special-purpose processor programmed with instructions to perform these steps. Alternatively, the steps may be performed by a combination of hardware, software, and/or firmware.

As shown, computer system 600 includes a bus 630, a processor 605, communication port 610, a main memory 615, a removable storage media 640, a read only memory 620 and a mass storage 625. A person skilled in the art will appreciate that computer system 600 may include more than one processor and communication ports.

Examples of processor 605 include, but are not limited to, an Intel® Itanium® or Itanium 2 processor(s), or AMD® Opteron® or Athlon MP® processor(s), Motorola® lines of processors, FortiSOC™ system on a chip processors or other future processors. Processor 605 may include various modules associated with monitoring unit as described in FIGS. 2-4. Communication port 610 can be any of an RS-232 port for use with a modem based dialup connection, a 10/100 Ethernet port, a Gigabit or 10 Gigabit port using copper or fiber, a serial port, a parallel port, or other existing or future ports. Communication port 610 may be chosen depending on a network, such a Local Area Network (LAN), Wide Area Network (WAN), a WLAN or any network to which computer system 600 connects.

Memory 615 can be Random Access Memory (RAM), or any other dynamic storage device commonly known in the art. Read only memory 620 can be any static storage device(s) such as, but not limited to, a Programmable Read Only Memory (PROM) chips for storing static information such as start-up or BIOS instructions for processor 605.

Mass storage 625 may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces), such as those available from Seagate (e.g., the Seagate Barracuda 7200 family) or Hitachi (e.g., the Hitachi Deskstar 7K1000), one or more optical discs, Redundant Array of Independent Disks (RAID) storage, such as an array of disks (e.g., SATA arrays), available from various vendors including Dot Hill Systems Corp., LaCie, Nexsan Technologies, Inc. and Enhance Technology, Inc.

Bus 630 communicatively couples processor(s) 605 with the other memory, storage and communication blocks. Bus 630 can be, such as a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects processor 605 to system memory.

Optionally, operator and administrative interfaces, such as a display, keyboard, and a cursor control device, may also be coupled to bus 630 to support direct operator interaction with computer system 600. Other operator and administrative interfaces can be provided through network connections connected through communication port 610.

Removable storage media 640 can be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM).

Components described above are meant only to exemplify various possibilities. In no way should the aforementioned exemplary computer system limit the scope of the present disclosure.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of this document terms “coupled to” and “coupled with” are also used euphemistically to mean “communicatively coupled with” over a network, where two or more devices are able to exchange data with each other over the network, possibly via one or more intermediary device.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc. The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

While embodiments of the present disclosure have been illustrated and described, it will be clear that the disclosure is not limited to these embodiments only. Numerous modifications, changes, variations, substitutions, and equivalents will be apparent to those skilled in the art, without departing from the spirit and scope of the disclosure, as described in the claim.

What is claimed is:

1. A method comprising:

[symbol]

2. The method of claim 1, wherein the network element comprises one or a combination of a network controller, a gateway, a router, a firewall, a hub and a switch.

3. The method of claim 1, wherein said detecting a potential rogue AP in the network comprises scanning, by the managed AP, the network for an AP that is not among those on a list of valid APs.

4. The method of claim 3, wherein the list of valid APs includes Media Access Control (MAC) addresses of the valid APs.

5. The method of claim 1, further comprising injecting, by the network element, the special network packet through a wired interface within one or more communication sessions associated with the potential rogue AP.

6. The method of claim 5, wherein the one or more communication sessions comprise a transmission control protocol (TCP) session and wherein the special network packet comprises a TCP packet.

7. The method of claim 5, wherein the one or more communication sessions comprise a user datagram protocol (UDP) session and wherein the special network packet comprises a UDP packet.

8. The method of claim 1, wherein the defined pattern comprises a length of the special network packet.

9. The method of claim 1, wherein the potential rogue AP comprises a layer 3 AP.

10. The method of claim 1, wherein said detecting whether the special network packet is transmitted by the potential rogue AP comprises receiving, by the managed AP, the special network packet on a wireless interface of the managed AP.

11. A system for detecting a rogue access point (AP) comprising:
a potential rogue AP identification module, operable within a managed AP of a network, configured to detect a potential rogue AP in the network;
a special packet injection module, operable within a network element on a wired side of the network, configured to inject a special network packet having a defined pattern onto the network;
a rogue AP evaluation module, operable within the managed AP, configured to detect whether the special network packet is transmitted by the potential rogue AP; and
wherein responsive to receiving an indication from the rogue AP evaluation module that the special network packet has been detected by the rogue AP evaluation module, the managed AP identifies the potential rogue AP as a confirmed on-wire rogue AP.

12. The system of claim 11, wherein the network element comprises one or a combination of a network controller, a gateway, a router, a firewall, a hub and a switch.

13. The system of claim 11, wherein the potential rogue AP is detected by the managed AP by scanning the network for an AP that is not among those on a list of valid APs.

14. The system of claim 13, wherein the list of valid APs includes Media Access Control (MAC) addresses of the valid APs.

15. The system of claim 11, wherein the network element injects the special network packet through a wired interface within one or more communication sessions associated with the potential rogue AP.

16. The system of claim 15, wherein the one or more communication sessions comprise a transmission control protocol (TCP) session and wherein the special network packet comprises a TCP packet.

17. The system of claim 15, wherein said one or more communication sessions comprise a user datagram protocol (UDP) session and wherein the special network packet comprises a UDP packet.

18. The system of claim 15, wherein the defined pattern comprises a length of the special network packet.

19. The system of claim 11, wherein the potential rogue AP comprises a layer 3 AP.

20. The system of claim 11, wherein the rogue AP evaluation module detects the special network packet when the managed AP receives the special network packet on a wireless interface of the managed AP.
